(19) United States
(12) Patent Application Publication
(10) Pub. No.: US 2015/0220229 A1
(43) Pub. Date: Aug. 6, 2015

(54) USER INTERFACE FOR END-OF-BOOK EXPERIENCE CROSSREFERENCE

(71) Applicant: KOBO INCORPORATED, Toronto (CA)

(72) Inventors: Sneha PATEL, Toronto (CA); Anthony O'DONOGHUE, Toronto (CA)

(73) Assignee: KOBO INCORPORATED, Toronto (CA)

(21) Appl. No.: 14/174,612

(22) Filed: Feb. 6, 2014

(51) Int. Cl. G06F 3/0483; G06F 3/0481

(52) U.S. Cl. CPC G06F 3/0483; G06F 3/04817

(57) ABSTRACT

System and method for presenting a customized aggregation of information based on specific state-of-mind of a user. An end-of-book experience graphical user interface (GUI) is configured to capture a specific state-of-mind of a user by using an options menu listing typical state-of-minds of typical book users. Provided the user indicates to expand reading experience on the instant book, a set of information that facilitates a deep dive experience on the instant book can be presented. Alternatively, provided the user indicates to move on from the instant book, a collection of books of in different categories from the instant can be recommended. The end-of-book experience GUI can be prompted upon a user indication of having finished reading a book, closing the reading program before finishing, or re-reading the book.

### TECHNICAL FIELD

The present disclosure relates generally to the field of electronic books, and, more specifically, to the field of graphical user interfaces for electronic books.

### BACKGROUND

The use of electronic devices to read books, newspapers and magazines has become increasingly commonplace due to the numerous significant advantages afforded by such devices over conventional paper print. For example, comparing to paper print, an electronic reading device can hold much greater amounts of information, allow immediate access to new books, personalize the reading display format, and facilitate night reading, etc. Electronic reading devices can be implemented as dedicated reading devices, e.g., e-readers, as well as general-purpose electronic devices, such as desktop, laptop and hand-held computers.

Moreover, various application programs installed on electronic reading devices and the associated servers provide convenient marketing channels for promoting the sale of electronic media products to users. Especially, the time that a user finishes reading a book is regarded as a good opportunity to promote other books to the user. A popular approach to utilize this opportunity is to present a list of recommended books to the user when it is detected that the user has finished reading a particular book.

The efficiency and effectiveness of such a promotion event to a particular user is naturally determined by the user's receptiveness of the recommendations, which is largely affected by the user's feelings and opinions towards the book that the user just read. Conventionally, the recommended media products are customized for the user based on the estimated and generalized state-of-mind of an average user. A few objective factors are commonly used to make the estimation, such as the classification of the instant book, the user's past purchase history, or the popularity of the recommended books, and so on.

However, a generalized and objective estimation may not accurately coincide well with a user's specific state-of-mind at a promotion event. In other words, according to the prior art techniques, the recommendations are presented to a user without taking into account his or her specific state-of-mind. Thus, conventional technologies for promotion marketing of the recommended books may not be efficient and effective.

### SUMMARY OF THE INVENTION

Therefore, it would be advantageous to provide a mechanism and system for improving marketing efficiency and effectiveness of on-line book promotion events. Accordingly, embodiments of the present disclosure employ a computer implemented method of presenting an end-of-book experience graphical user interface (GUI) that is configured to capture a user's specific state-of-mind at the time of promotion event, and thereby present a customized aggregation of information to the user. The end-of-book experience GUI may include an options menu that lists typical states-of-mind of typical book users. Depending on a user's selection from the options with respect to his or her state-of-mind, a select aggregation of information is presented to the user.

Particularly, if the user indicates to expand the reading experience on the same book, e.g., “want more” on the current book, varieties of information pertaining to the book can be presented, including external information on key terms motioned in the book, derivative works of the book, a biography of the author, a collection of books by the author, and etc. Such information may also be presented when a user intends to re-read the book. Alternatively, if the user indicates to move on from the instant book or its topic to another one, a collection of books of in different categories from the instant can be recommended. The end-of-book experience graphical user interface (GUI) can be prompted upon a determination that the user has finished reading a book.

In one embodiment of the present disclosure, a computer implemented method of presenting information related to an electronic book on a display device comprises: (1) rendering a first graphical user interface (GUI) on the display device; (2) receiving a first user interaction with the first graphical user interface (GUI), wherein the first user interaction indicates a state-of-mind of the user with respect to the electronic book; (3) accessing a select aggregation of information related to the electronic book, wherein the aggregation of information is dependent on the user interaction; (4) rendering a second GUI on the display device; and (5) displaying the select aggregation of information within the second GUI. The first GUI may be prompted when the user indicates that he or she finished reading a book, intends to abandon reading the book, or intends to re-read the book.

Provided the first user interaction indicates the user's intention to expand knowledge on the electronic book, the select aggregation of information comprises: external information on key terms contained in the electronic book; a collection of electronic books by an author of the electronic book; other media products with a same title of the electronic book; and/or a biography of the author. Alternatively, provided the first user interaction indicates the user's intention to change to another electronic book, the aggregation of information comprises: a list of electronic books having topics different from the electronic book.

In another embodiment of the present disclosure, a non-transitory computer-readable storage medium embodying instructions that, when executed by a processing device, cause the processing device to perform a method of presenting information relevant to an electronic book through a display device. The method comprises: (1) receiving a user instruction through the display device, the user instruction indicating a conclusion of reading the electronic book by the user; (2) rendering a first on-screen GUI on the display device in response to the user instruction, wherein the first on-screen GUI comprises a menu comprising a plurality of options corresponding to user states-of-mind with respect to the electronic book; (3) receiving a user selection from the plurality of options; (4) accessing a select collection of related information of the electronic book, wherein the select collection of related information is customized to the user selection; (4) rendering a second on-screen GUI on the display device; and (5) displaying the select collection of related information within the second GUI.

In another embodiment of the present disclosure, a system comprises: a processor; a communication circuit for communicating over a network channel; and memory coupled to said processor and comprising instructions that, when executed by said processor, cause the system to perform an method of rendering recommended media products related to an electronic book on a display device. The method comprise: (1) rendering a first graphical user interface (GUI) on said display device; (2) receiving a first user interaction with said first GUI, wherein said first user interaction indicates a state-of-mind of said user with respect to said electronic book; (3) accessing a select aggregation of information related to said electronic book, wherein said select aggregation of information is dependent on said user interaction; (4) rendering a second GUI on said display device; and (5) displaying said select aggregation of information within said second GUI.

This summary contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 is a flow chart depicting an exemplary computer implemented method of automatically presenting relevant information based on a user's state-of-mind with respect to a book in accordance with an embodiment of the present disclosure.

FIG. 2 is an exemplary configuration of an on-screen GUI configured to identify a user's state-of-mind at the time of a promotion event in accordance with an embodiment of the present disclosure.

FIG. 3 illustrates exemplary configurations of on-screen GUIs that are spawned from the experience GUI in FIG. 2 as a result of respective user selections in accordance with an embodiment of the present disclosure.

FIG. 4A illustrates a reading experience GUI with a GUI button serving to receive a user indication that the user has finished reading the instant book

FIG. 4B illustrates an exemplary on-screen annotation display window configured to display an annotation dialog between an author and the reader community in accordance with an embodiment of the present disclosure.

FIG. 5A illustrates an on-screen GUI configured to present a library of “already read” books by a user.

FIG. 5B illustrates an exemplary on-screen GUI configured to specifically identify a user's state-of-mind when the user indicates to revisit a book that he or she already finished in accordance with an embodiment of the present disclosure.

FIG. 6A illustrates an exemplary on-screen reading experience GUI with GUI buttons and serving to identify the user's specific state-of-mind when the user closes the book before finishing it in accordance with an embodiment of the present disclosure

FIG. 6B illustrates an exemplary on-screen GUI configured to display a collection of books from categories different from the instant book upon receiving a user indication of abandoning the instant book according to an embodiment of the present disclosure.

FIG. 7 is a block diagram illustrating an exemplary computing system including a reading experience program that can present an aggregation of relevant information based on an identified user's state-of-mind in accordance with an embodiment of the present disclosure.

### DETAILED DESCRIPTION

Reference will now be made in detail to the preferred embodiments of the present invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of embodiments of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail so as not to unnecessarily obscure aspects of the embodiments of the present invention. The drawings showing embodiments of the invention are semi-diagrammatic and not to scale and, particularly, some of the dimensions are for the clarity of presentation and are shown exaggerated in the drawing Figures. Similarly, although the views in the drawings for the ease of description generally show similar orientations, this depiction in the Figures is arbitrary for the most part. Generally, the invention can be operated in any orientation.

### Notation and Nomenclature:

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “accessing” or “executing” or “storing” or “rendering” or the like, refer to the action and processes of a computer system, or similar electronic computing device, that manipulates and transforms data represented as physical (electronic) quantities within the computer system's registers and memories and other computer readable media into other data similarly represented as physical quantities within the computer system memories or registers or other such information storage, transmission or client devices. When a component appears in several embodiments, the use of the same reference numeral signifies that the component is the same component as illustrated in the original embodiment.

### A User Interface for End-of-Book Experience

Overall, embodiments of the present disclosure employ a computer implemented method of presenting an end-of-book experience graphical user interface (GUI) configured to capture a user's specific state-of-mind at the time of promotion event, and thereby present a customized aggregation of related information. The end-of-book experience GUI may include an options menu listing typical states-of-mind of typical book users. Depending on the user's selection from the options with respect to his or her state-of-mind, a select aggregation of information is presented to the user, e.g. for book promotion purposes.

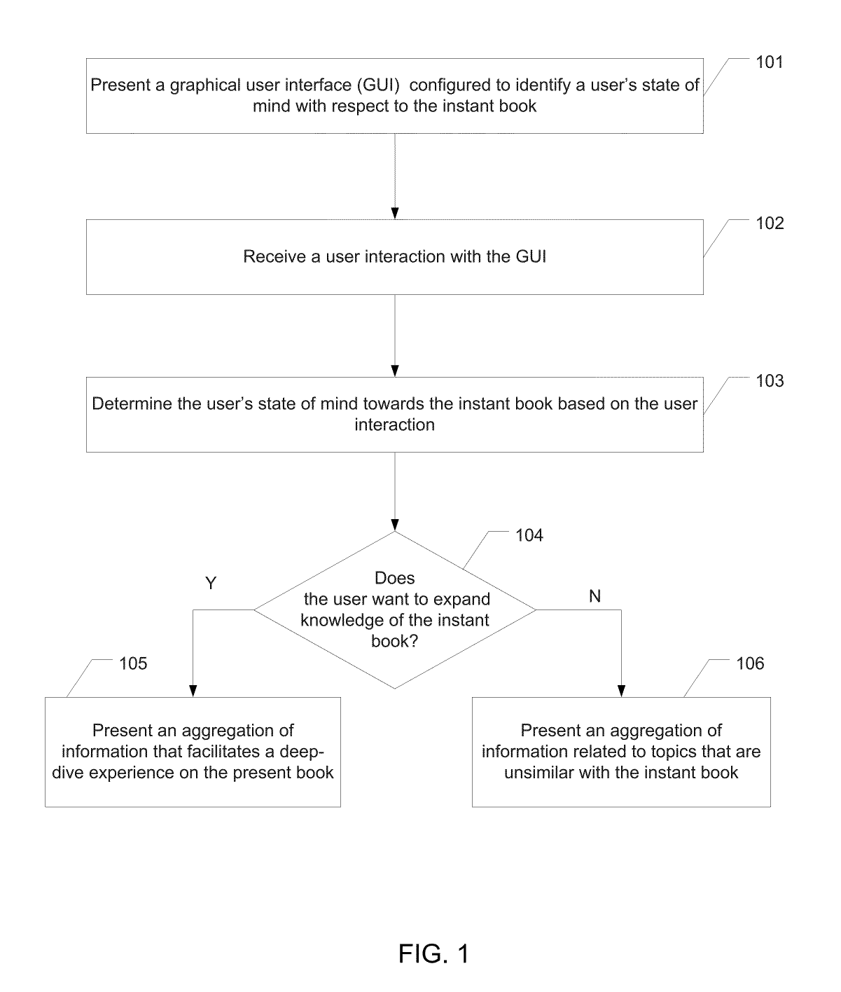

FIG. 1 is a flow chart depicting an exemplary computer implemented method 100 of automatically presenting relevant information based on a user's state-of-mind with respect to a book in accordance with an embodiment of the present disclosure. Method 100 may be implemented as a software program on an electronic reading device as an integral part of a book reading experience program, or a separate application program.

At 101, an end of-reading experience GUI designed to identify a user's state-of-mind with respect to an instant book is displayed on a reading device. In some embodiments, the GUI may have an options menu including a list of typical States-of-mind, as will be described in greater detail below. At 102, a user interaction with the GUI is received. For example, the user interaction corresponds to the user's selection from the state-of-mind options presented in the GUI. At 103, based on the user interaction, the user's state-of-mind towards the book is identified and is used as input to determine an aggregation of information for presentation.

Based on the identified state-of-mind, if it is determined that the user intends to remain on the same topic of book or even to read it again at 104, an aggregation of information that facilitates a deep dive experience on the instant book is presented at 105. The aggregation of information may include any information pertinent to the book, such as external information on key terms mentioned in the book, a biography of the author, a collection of the author's books, an author's annotation on the book, public annotations on the book, a public forum on the book, other media products or derivative works of the book, or other books of the same or similar title, etc. On the other hand, if the user indicates to move on from the book to new books, another aggregation of information in different categories other than the instant book can be recommended at 106.

Thus, according to the present disclosure, the user can conveniently elect to remain in the same topic and/or gain a deep dive experience on the instant book, and alternatively to explore other categories than the instant book. Because the presented information is tailored to the specific state-of-mind and taste of the individual user, at the time of promotion event, the effectiveness and efficiency of the promotion event can be significantly improved.

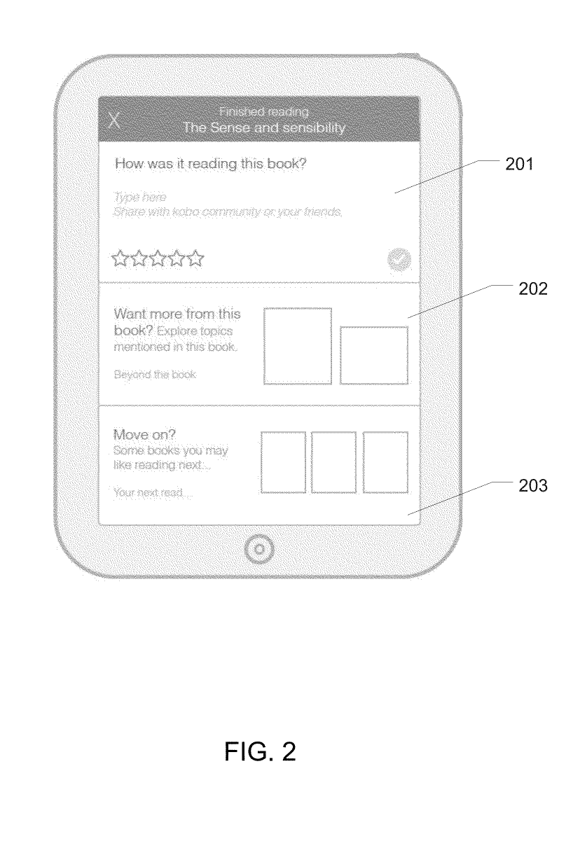

FIG. 2 is an exemplary configuration of an on-screen GUI 200 configured to identify a user's state-of-mind at the time of a promotion event in accordance with an embodiment of the present disclosure. In a simplest form, the GUI 200 includes an options menu listing two distinctive options with respect to a user's taste for more information: e.g., “want more from this book” and “move on.”

If the user is interested in exploring topics mentioned in the book and have a deep dive experience on the book , or alike, a selection of the “want more from this book” option 202 can lead to another GUI comprising an aggregation of information pertaining to the book. On the other hand, if the user is interested in moving on from the current book to a new book, e.g., to have a different reading experience, the user can select the “move on” option 203 which leads to the presentation of a list of recommended books of different topics or categories. The user may select the “move on” option whether or not he or she actually intends to come back to the current book at a later time.

Although FIG. 2 lists only two options, an option menu according to the present disclosure may encompass any number of States-of-mind of any type. The states-of-mind may include those that are material to provide a better reading experience and/or promotion efficiency. It will be appreciated that the option menu can be implemented in any suitable design or configuration. Depending on the embodiments, the listed States-of-mind can be described in any suitable expressions, such as various phrases, symbols, colors, images, sounds, a combination thereof, and etc.

In some other embodiments, specific state-of-mind of a user can be identified in any suitable method other than using an options menu. For example, user-input of text, symbols, colors, or voice can be received through a GUI and used to interpret the user's state-of-mind. Further, the GUI 200 may also include any other GUI gadgets, functions or content, e.g., a rating widget and a sharing widget.

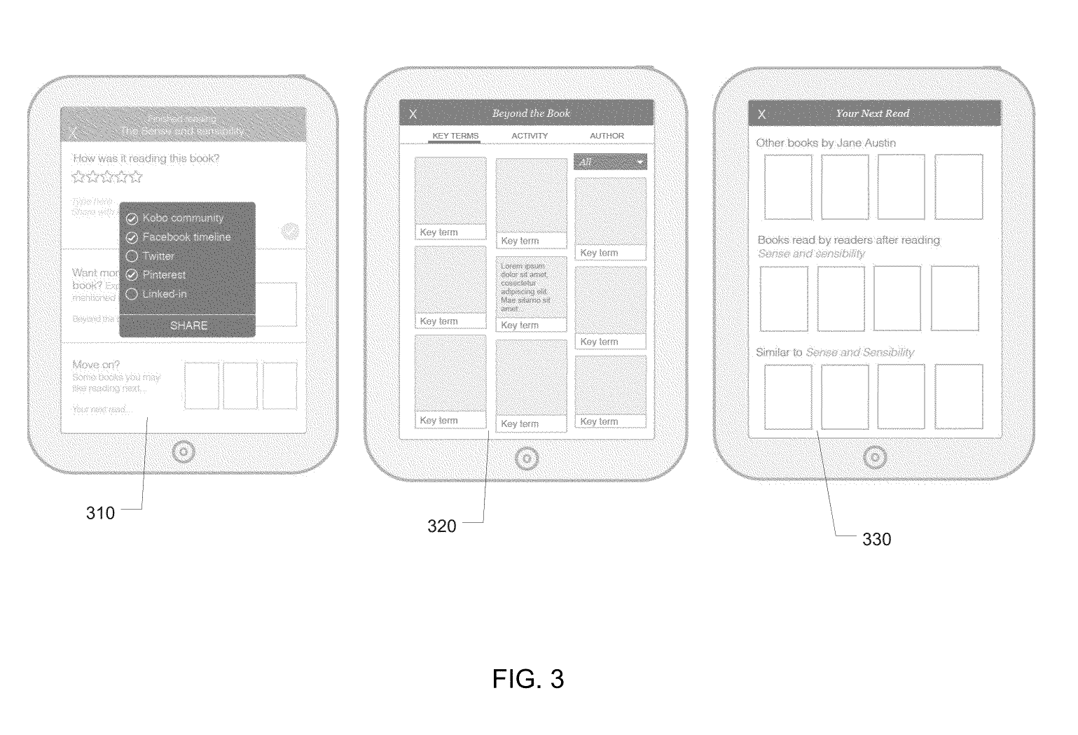

FIG. 3 illustrates exemplary configurations of on-screen GUIs 310, 320 and 330 that are spawned from the experience GUI in FIG. 2 as results of respective user selections in accordance with an embodiment of the present disclosure. If the “sharing” option 201 in FIG. 2 is selected, the GUI 310 allows the user to share his or her selected state-of-mind and/or rating on the book to one or more social media networks through the Internet, such as a book community, Facebook timeline, Twitter, Pinterest and Linked-in.

The GUI 320 can be displayed if the user elects to explore more on the book, e.g., by the “want more from this book” option 202 in FIG. 2. In some embodiments, the GUI 320 integrates extensive information on the instant book to facilitate the user to engage in a deep dive experience, such as external information on interesting terms or key terms mentioned in the book, interesting subjects mentioned in the book, external information related to the author, other media products, event, and activities related to the book, public forums and annotations on the book, etc.

The present disclosure is not limited by specific methods of determining a set of deep-dive information or any set of recommendations in accordance with a user-indicated state-of-mind. The process of automatically generating an aggregation of information in response to a user's input can be performed on a user's electronic device or alternatively on a server device, such as an on-line book store. In some embodiments, a user's interaction with an end-of-book experience GUI (e.g., GUI 200 in FIG. 2) can be recorded by a server device for statistic data accumulation and analysis. The statistic results in turn can be incorporated in determining a select aggregation of information presented to subsequent users.

For example, the key terms may be automatically selected from the book according to on a TF-IDF-based content analysis process. One or more external information source sites, e.g., Wikipedia, can be used to provide external information on the key terms according to a vilification process. A disambiguation process can be used to select the most relevant definition for multi-sense key terms that have multiple definitions within a selected information source. The GUI 320 may also include a list of videos, music, images, games and other media products related to the instant book or to the topic of the instant book.

The GUI 333 can be displayed if the user elects to move to another book, e.g., by the “move on” option 203 in FIG. 2. In some embodiments, the GUI 300 presents recommendations of books in which the user might be interested. The recommendations may be determined based on any combination of factors and method that are well known in the art. For example, the classification of the book, the book author, the instant user's purchase history, and other users purchase behavior, and other factors can be comprehensively taken into account to outcome a recommendation list that likely match the user's interest.

In this example, the recommended books includes a set of books by the same author as the instant book, a set of books read by other readers after reading the instant book, and a set of books in the same category of the instant book. In some embodiments, the recommendations may include other media products, such as videos, music, images, and etc.

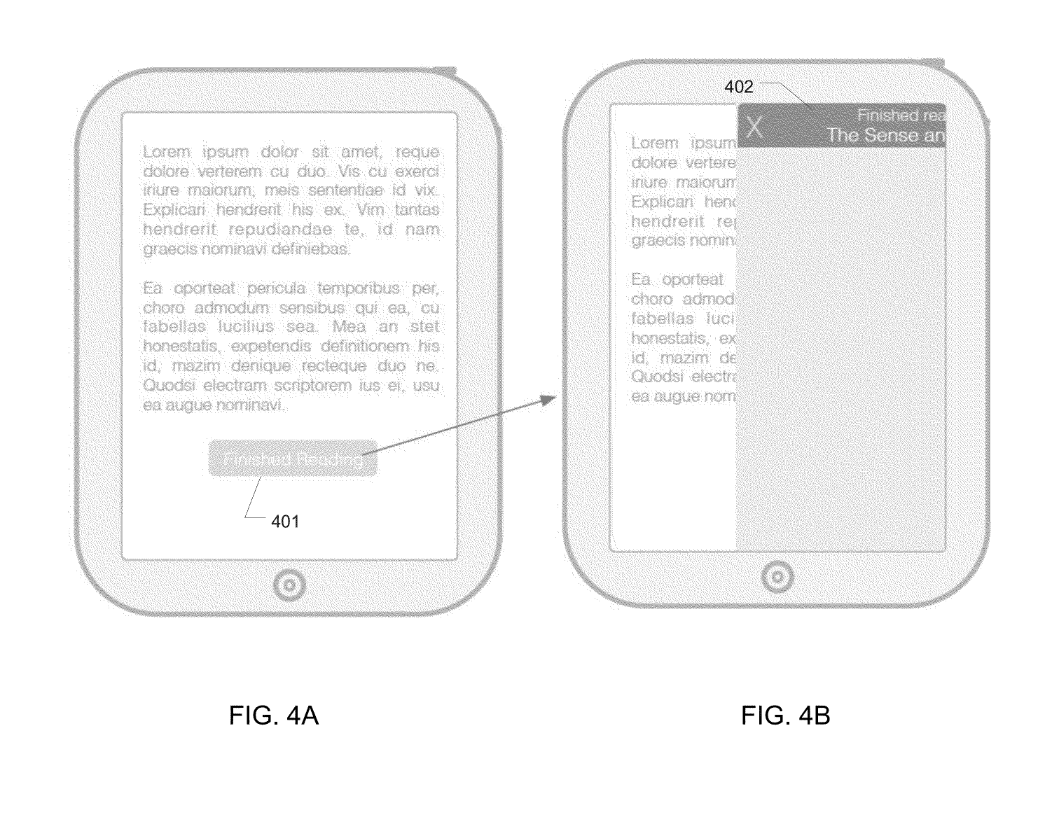

The present disclosure is not limited to any entry GUI that can lead to the presentation of an on-screen GUI that is configured to identify a user's specific state-of-mind (e.g., GUI 200 in FIG. 2) in accordance with an embodiment of the present disclosure. FIG. 4 illustrates a reading experience GUI 410 with a GUI button serving to receive a user indication that the user has finished reading the instant book. In this example, the reading experience GUI 410 is configured to display the content of the book. A “Finished Reading” button is shown in the middle of the last page of the book. The “Finished Reading” button may be presented upon the user actually finishes reading the book or reaches the last page by skipping a portion of the book.

When a user confirms finishing reading the book by clicking the button, an end-of-page GUI 402 may overlay on the reading experience GUI 410. In some embodiments, the end-of-page GUI 402 has the similar configuration as the GUI 200 in FIG. 2, as described in greater detail above.

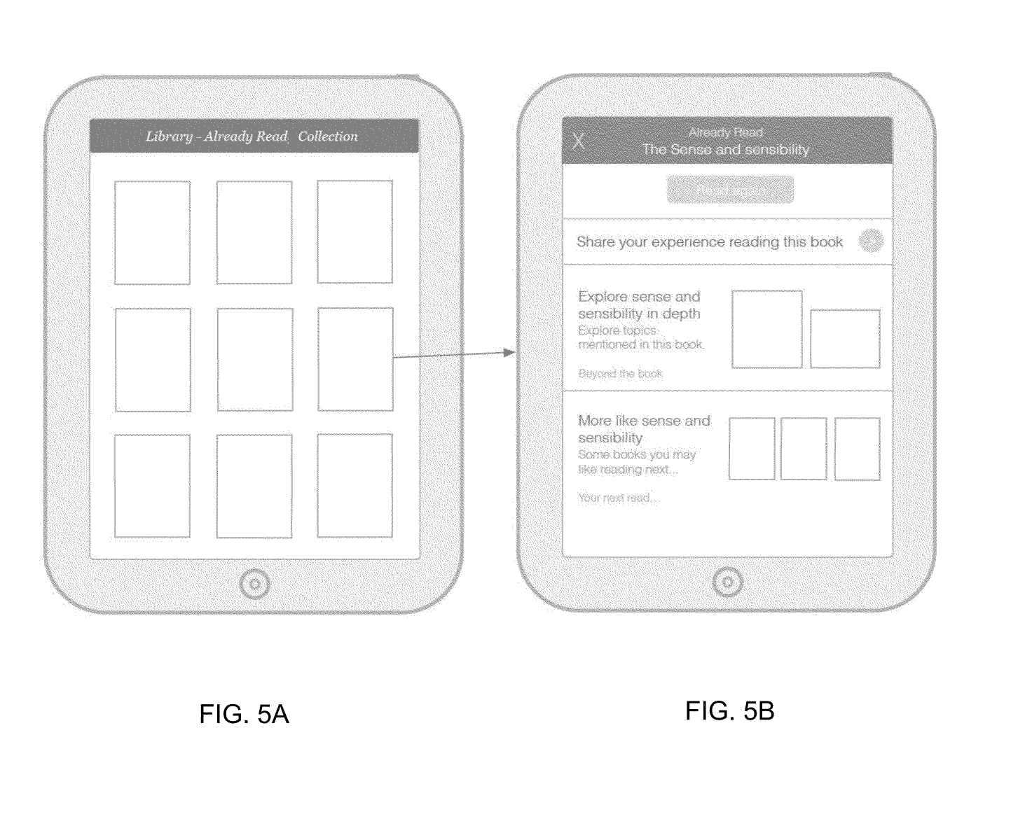

In some embodiments, a reading experience program may maintain a collection of “already read” books by a user, which allows a user to conveniently keep a record and revisit a book that he or she has actually already finished reading or indicated so by clicking the “Finished Reading” button. FIG. 5A illustrates an on-screen GUI configured to present a library of “already read” books by a user. Conventionally, upon a user selecting a book from the “already read” library, the reading program is configured to display the content of the book directly. However, the user's intention to re-read a book is likely associated with an interest in a deep dive experience in the book and/or in reading other books similar with the book. In other words, the time that the user indicates to re-read a book may be utilized as an opportunity to present related information and/or promote other books.

FIG. 5B illustrates an exemplary on-screen GUI 520 configured to specifically identify a user's state-of-mind when the user indicates to revisit a book that he or she already finished in accordance with an embodiment of the present disclosure. The GUI 520 includes an options menu from which a user can elect to explore the instant book further 521, see recommendations of similar books 523, or re-read the instant book immediately 523. The user can also share his or her reading experience on the Internet by selecting 524.

Upon a user choosing to explore the topics mentioned in the book 521, another GUI including information for a deep dive experience on the instant book can be displayed, as described in greater detail with reference to the GUI 200 in FIG. 2. If a user selects to learn about books of “more like” the instant book 522, a collection of books in the same category as the instant book may be presented to the user.

It will be appreciated that the present disclosure is not limited to any list of states-of-mind included in a GUI triggered by a user indication of re-reading a book, e.g., GUI 520. Also, a collection of “more like” the instant book can be automatically determined in any suitable method that is well known in the art.

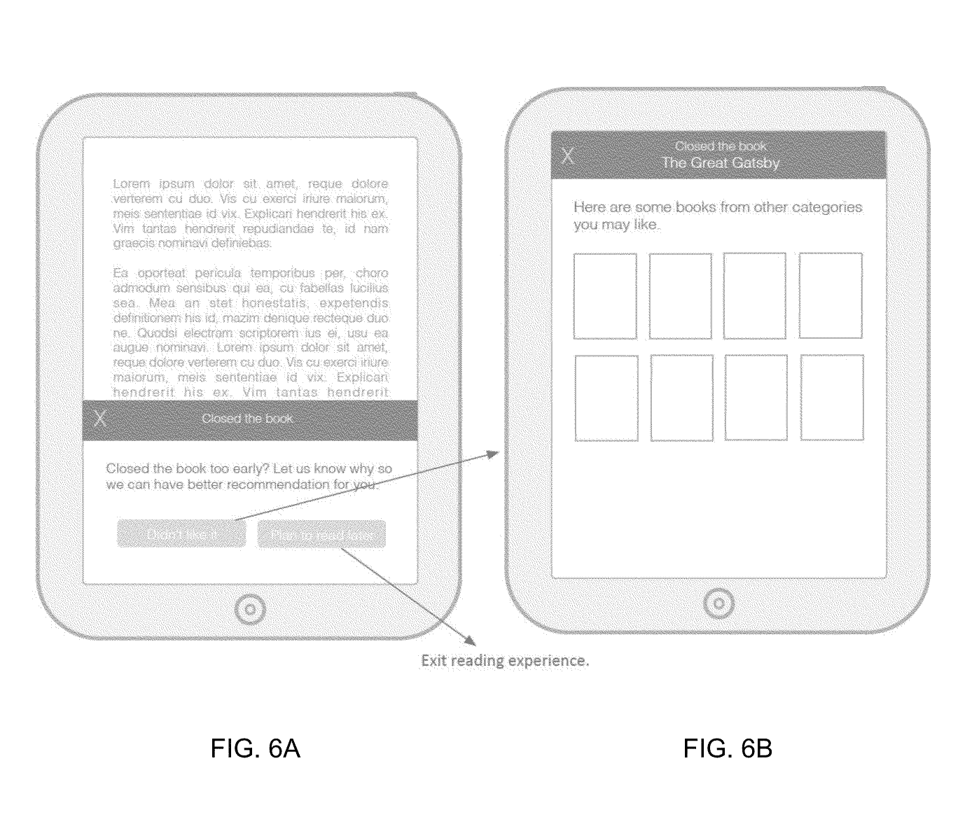

Each time a user closes a book, there is a chance that the user decides to abandon the book without finishing it. This is regarded as an opportunity that can be utilized to introduce books that are different from the instant book. FIG. 6A illustrates an exemplary on-screen reading experience GUI 610 with GUI buttons 611 and 612 serving to identify the user's specific state-of-mind when the user closes the book before finishing it in accordance with an embodiment of the present disclosure. In this example, upon a user indicates to close the instant book, a “didn't like it” button and a “plan to read later” button are displayed.

When a user clicks the “didn't like it” button, a collection of books and/or other media products from other categories are recommended and displayed on the screen instead of closing the book. FIG. 6B illustrates an exemplary on-screen GUI configured to display a collection of books from categories different from the instant book upon receiving a user indication of abandoning the instant book according to an embodiment of the present disclosure. This collection of books can be automatically determined in any suitable method that is well known in the art.

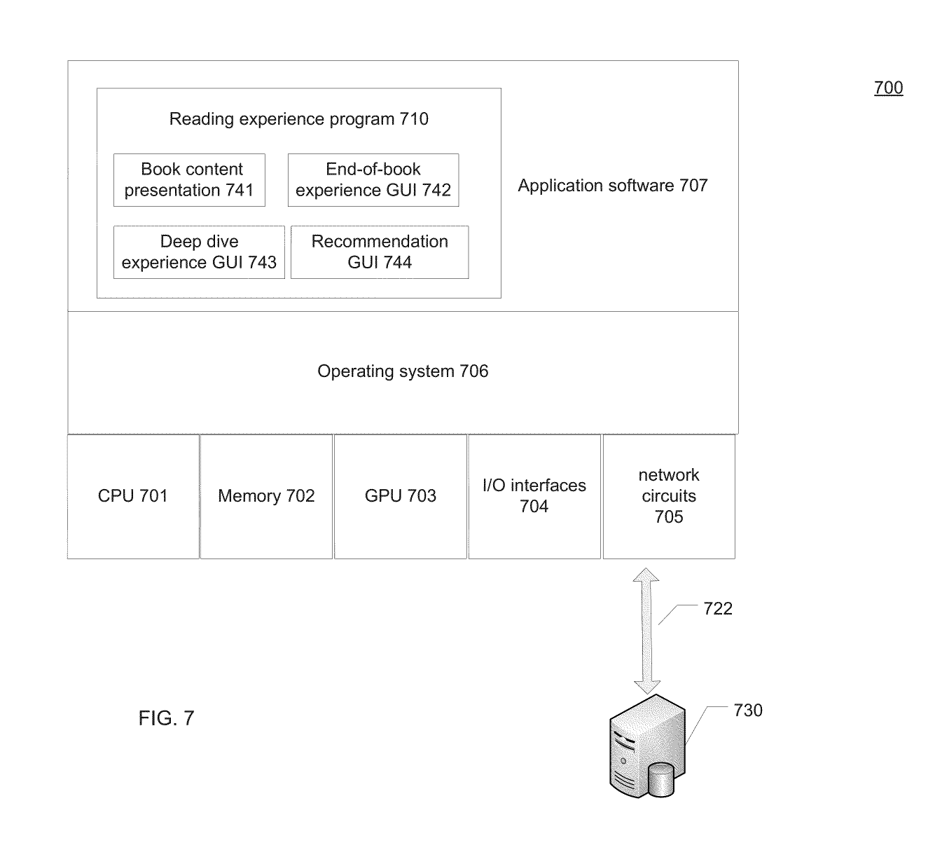

FIG. 7 is a block diagram illustrating an exemplary computing system 700 including a reading experience program 710 that can present an aggregation of relevant information based on an identified user's state-of-mind in accordance with an embodiment of the present disclosure. The computing system 700 comprises a processor 701, system memory 702, a GPU 703, I/O interfaces 704, network circuits 705, an operating system 706 and application software 707 including the reading experience program 710 stored in the memory 702. In the illustrated example, the computing system 700 is coupled to a server 730 through a communication channel 722. The server 730 may be hosted by an on-line book store, a library, a publisher, or other book provider alike, etc.

In the illustrated example, the reading experience program 710 comprises a book content presentation module 741, an end-of-book experience GUI module 742, a deep-dive experience GUI module 743 and a recommendation GUI module 744.

When incorporating configuration input and personalized input and executed by the CPU 701, the reading experience program 710 can present book content through the book content presentation module 741. The end-of-book experience GUI module 742 is configured to present a GUI (e.g., GUI 200 in FIG. 2) to identify a user's specific state-of-mind at one of the several predetermined events, including when the user finishes reading a book, indicates to close the reading experience program, and indicates to re-read a book. User interactions with the end-of-book experience GUI that indicates a state-of-mind of the user may be transmitted through the communication network 722 to the server 730 for processing.

The deep dive experience GUI module 743 is configured to present an aggregation of information pertinent to the instant book responsive to a predetermined user interaction with the end-of-book experience GUI. The module 743 may be configured to generate such information or access locally or access such information through the communication network 722 from the server 730. In the latter case, the server 730 is configured to receive the user interactions with the end-of-book experience GUI and thereby automatically generate an aggregation of deep dive experience information.

The recommendation GUI module 744 is configured to present an aggregation of book recommendations responsive to another predetermined user interaction with the end-of-book experience GUI. The module 744 may be configured to generate such information or access locally or access such information through the communication network 722 from the server 730. In the latter case, the server 730 is configured to receive the user interactions with the end-of-book experience GUI and thereby automatically generate a collection of books that may suits to the user's interest.

The reading experience program 710 may perform various other functions as discussed in details with reference to FIG. 1-FIG. 6B. As will be appreciated by those with ordinary skill in the art, the reading experience program 710 can be implemented in any one or more suitable programming languages that are known to those skilled in the art, such as C, C++, Java, Python, Perl, C#, SQL, etc.

Although certain preferred embodiments and methods have been disclosed herein, it will be apparent from the foregoing disclosure to those skilled in the art that variations and modifications of such embodiments and methods may be made without departing from the spirit and scope of the invention. It is intended that the invention shall be limited only to the extent required by the appended claims and the rules and principles of applicable law.

What is claimed is:

1. A computer implemented method of presenting information related to an electronic book on a display device, said computer implemented method comprising:
rendering a first graphical user interface (GUI) on said display device;
receiving a first user interaction with said first graphical user interface (GUI), wherein said first user interaction indicates a state-of-mind of said user with respect to said electronic book;
accessing a select aggregation of information related to said electronic book, wherein said aggregation of information is dependent on said user interaction;
rendering a second GUI on said display device; and
displaying said select aggregation of information within said second GUI.

2. The computer implemented method of claim 1, wherein, provided said first user interaction indicates said user's intention to expand knowledge on said electronic book, said select aggregation of information comprises: external information on key terms contained in said electronic book; a collection of electronic books by an author of said electronic book; other media products with a same title of said electronic book; and/or a biography of said author.

3. The computer implemented method of claim 1 further comprising rendering a third graphical user interface (GUI) configured to display content of said electronic book, wherein said third GUI comprises a graphical button representing an event that said user finished reading said electronic book, and wherein said rendering said first GUI comprises rendering said first GUI in response to a second user interaction with said graphical button.

4. The computer implemented method of claim 2 further comprising rendering a third graphical user interface (GUI) comprising a list of books that said user has finished reading, wherein said third GUI comprises a graphical button representing said electronic book, wherein said rendering said first GUI comprises rendering said first GUI in response to a second user interaction with said graphical button, and wherein further said second user interaction indicates an intention of said user to repeat reading said electronic book.

5. The computer implemented method of claim 1, wherein, provided said first user interaction indicates said user's intention to change to another electronic book, said aggregation of information comprises: a list of electronic books having different topics than said electronic book.

6. The computer implemented method of claim 5 further comprising rendering a third graphical user interface (GUI) configured to display content of said electronic book, wherein said third GUI comprises a graphical button representing that said user intends to stop reading said electronic book for an extended time, and wherein said rendering said first GUI comprises rendering said first GUI in response to receiving a user interaction with this said graphical button.

7. The computer implemented method of claim 6 further comprising rendering said graphical button on said third GUI when responsive to receiving a user instruction to close said third GUI.

8. The computer implemented method of claim 6, wherein said second GUI is further configured to receive a user indication to publish said state-of-mind through a social media website.

9. A non-transitory computer-readable storage medium embodying instructions that, when executed by a processing device, cause the processing device to perform a method of presenting information relevant to an electronic book through an display device, said method comprising:
receiving a user instruction through said display device, said user instruction indicating a completion of reading said electronic book by said user;
rendering a first on-screen graphical user interface (GUI) on said display device in response to said user instruction, wherein said first on-screen GUI comprises a menu comprising a plurality of options corresponding to user states-of-mind with respect to said electronic book;
receiving a user selection from said plurality of options;
accessing a select collection of related information of said electronic book, wherein said select collection of related information is customized to said user selection;
rendering a second on-screen GUI on said display device; and
displaying said select collection of related information within said second GUI.

10. The non-transitory computer-readable storage medium of claim 9, wherein said method further comprises rendering a third on-screen GUI configured to display content of said electronic book, wherein said third on-screen GUI comprises a visual object, and wherein said user instruction corresponds to a user interaction with said visual object to indicate that said user has completed reading said electronic book.

11. The non-transitory computer-readable storage medium of claim 9, wherein said method further comprises rendering a third on-screen GUI configured to display content of said electronic book, wherein said third on-screen GUI comprises a visual object, wherein said user instruction corresponds to a user interaction with said visual object to indicate that said user intends to abandon reading said electronic book without returning thereto.

12. The non-transitory computer-readable storage medium of claim 9, wherein said plurality of options comprise an icon related to an intention to explore further on said electronic book, and an icon related to an intention to move on from said electronic book.

13. The non-transitory computer-readable storage medium of claim 12, wherein, provided said user selection corresponds to said intention to explore further, said collection of related information comprises: external information on key terms contained in said electronic book; a collection of electronic books by an author of said electronic book; other media products with a same title of said electronic book; and/or a biography of said author.

14. The non-transitory computer-readable storage medium of claim 12, wherein, provided said user selection corresponds to said intention to move on from said electronic book, said select collection of related information comprises: external information on key terms contained in said electronic book; a collection of electronic books by an author of said electronic book; other media products with a same title of said electronic book; and/or a biography of said author.

15. The non-transitory computer-readable storage medium of claim 9, wherein said method further comprises rendering said first on-screen graphical user interface (GUI) on said display device in response to another user instruction to open said electronic book after said user has finished reading said electronic book.

16. A system comprising:
a processor;
a communication circuit for communicating over a network channel; and
memory coupled to said processor and comprising instructions that, when executed by said processor, cause the system to perform an method of rendering recommended media products related to an electronic book on a display device, said method comprising:
rendering a first graphical user interface (GUI) on said display device;
receiving a first user interaction with said first graphical user interface (GUI), wherein said first user interaction indicates a state-of-mind of said user with respect to said electronic book;
accessing a select aggregation of information related to said electronic book, wherein said select aggregation of information is dependent on said user interaction;
rendering a second GUI on said display device; and
displaying said select aggregation of information within said second GUI.

17. The system of claim 16, wherein, provided said first user interaction indicates an intention of said user to expand knowledge on said electronic book, said select aggregation of information comprises: external information on key terms contained in said electronic book; a collection of electronic books by an author of said electronic book; other media products with a same title of said electronic book; and/or a biography of said author.

18. The system of claim 16, wherein said method further comprises rendering a third graphical user interface (GUI) configured to display content of said electronic book, wherein said third GUI comprises a graphical button representing an event wherein said user finished reading said electronic book, and wherein said rendering said first GUI comprises rendering said first GUI in response to a second user interaction with said graphical button.

19. The system of claim 16, wherein said method further comprises rendering a third graphical user interface (GUI) comprising a list of books that said user has finished reading, wherein said third GUI comprises a graphical button representing said electronic book, wherein said rendering said first GUI comprises rendering said first GUI in response to a second user interaction with said graphical button, and wherein further said second user interaction indicates an intention of said user to repeat reading said electronic book.

20. The system of claim 16, wherein, provided said first user interaction indicates an intention of said user to change to another electronic book, said select aggregation of information comprises: a list of electronic books having topics different from said electronic book.
